(19) United States
(12) Patent Application Publication
(10) Pub. No.: US 2005/0069710 A1
(43) Pub. Date: Mar. 31, 2005

(54) Thermoformable multilayer film based on acrylic polymer for protecting substrates and resulting objects

(76) Inventors: Anthony Bonnet, Beaumont Le Roger (FR); Marius Hert, Serquigny (FR); Gilles Marot, Bernay (FR); David Silagy, Evreux (FR)

Correspondence Address: Thomas F Roland;Atofina Chemicals Inc, 2000 Market Street, Philadelphia, PA, 19103, US

(21) Appl. No.: 10/496,922

(22) PCT Filed: Nov. 29, 2002
(86) PCT No.: PCT/FR02/04107

(30) Foreign Application Priority Data
Nov. 29, 2001 (FR) 0115437

(51) Int. Cl. B32B 27/30

(52) U.S. Cl. 428/411.1

(57) ABSTRACT

The present invention relates to a thermoformable multilayer film comprising in succession: an optional protective layer (A); a layer (B) comprising (the total being 100% by weight) 0 to 30% of a fluoropolymer (B1) and 100 to 70% of a functionalized polymer (B2) essentially consisting of alkyl (meth)acrylate units; a layer (C) based on an ethylene/alkyl (meth)acrylate/unsaturated epoxide copolymer; a polyolefin tie layer (D); the layers adhering to one another in their respective contact regions. This film is obtained by coextrusion or coating of the various layers, the layer (A) possibly being laminated using the standard technique for thermoplastics. This film is then used to cover various substrates, for example by injecting the substrate in the melt onto the multilayer film deposited in the bottom of an injection mould, the layer (B) or the optional layer (A) of the film being placed against the wall of the mould. The present invention also relates to the substrates coated with these films.

This application claims benefit, under U.S.C. §119 or §365 of French Application Number 01/15437, filed Nov. 29, 2001; and PCT/FR02/04107 filed Nov. 29, 2002.

### FIELD OF THE INVENTION

The present invention relates to an acrylic-polymer-based thermoformable multilayer film for the protection of substrates and to the objects thus obtained.

### BACKGROUND OF THE INVENTION

Use is made, particularly in the motor-vehicle industry, of many body parts made of plastic, such as bumpers, wing mirrors, the bonnet and increasingly all the other parts such as the doors and wings. These parts have the advantage of being lighter than the same parts made of steel, of being insensitive to corrosion and of having superior mechanical properties. These parts are produced by melt-injection-moulding and/or thermoforming of a thermoplastic. However, there is a technical difficulty, namely that they are far more difficult to paint than steel. One solution consists in covering these parts with a coloured film, this film possibly being a monolayer or a multilayer. Usually, this film is placed in the bottom of a mould and then the molten plastic (the substrate) is injected onto it and, after cooling and demoulding, the part coated with the coloured film is obtained; this is the technique of overmoulding. The adhesion of the film is provided by contact between the molten plastic and the film, causing that surface of the film facing the injection of the molten plastic to melt and thus to be welded. It is also possible to coextrude the substrate and the coloured film, to coat the substrate on the coloured film or to hot-press the substrate onto the coloured film, and then optionally to thermoform the assembly.

The present invention relates to these films and to the substrates coated using this technique.

U.S. Pat. No. 5,514,427 proposes the use of the technique called solvent casting for uniformly dispersing pigments, dyes and fillers in a multilayer film. The solvent casting technology consists firstly in producing a liquid thermoplastic polymer composition in a solvent containing the actual polymers, the dispersion of pigments and the additives meeting a given specification. This liquid composition is then uniformly deposited on a supporting strip. The latter is taken into a drying oven in which the solvents are extracted by evaporation and in which the composition is melted in order to form a continuous layer. The continuous film is then wound up. The structure of the film comprises, bearing from the inside (the substrate side, which is made of a polyolefin or acrylonitrile-butadiene-styrene) to the outside, a layer of a chlorinated polyolefin, an acrylic adhesive layer and a pigmented layer based on a fluoropolymer and on alkyl methacrylate.

U.S. Pat. No. 6,096,396 describes a multilayer film obtained by the technique called solvent casting and lamination, which has, respectively from the inside (substrate side) to the outside, an adhesive layer of the pressure-sensitive adhesive type, an opaque pigmented layer of a fluoropolymer in which the fillers have no particular orientation and a transparent layer based on a fluoropolymer.

EP 949 120 proposes a multilayer film consisting, from the inside to the outside, of a polymer support layer (polyolefin, acrylo-nitrile-butadiene-styrene, polyamide, etc.), of a methacrylate base layer, of a colour-pigmented fluorinated layer (with no particular orientation) and of a transparent fluorinated layer, it then being possible for this film to be overmoulded by various substrates, such as polyolefin or polyamide substrates.

U.S. Pat. No. 5,725,712 proposes a thermoformable multilayer film obtained by lamination, consisting, from the inside to the outside, of an adhesive layer, of a pigmented colour layer, in which the fillers have no particular orientation, and of a transparent layer.

U.S. Pat. No. 5,707,697 describes an external decorated and weather-resistant body part.

This part consists of a multilayer film, obtained by the technique called solvent casting, followed by lamination, and of a substrate. The structure of the film comprises, from the inside to the outside, a chlorinated polyolefin layer capable of adhering to a polyolefin substrate, a pigmented colour fluoropolymer-based layer in which the fillers do not have any particular orientation and a transparent fluoropolymer layer having a shiny appearance.

U.S. Pat. Nos. 6,254,712 and 6,336,988 describes a multilayer structure which, from the inside to the outside, has a reinforcing layer (of the ABS type) coated by coextrusion with an adhesion primer (acrylic), then with a coloured layer consisting of a PVDF-based copolymer as a blend with an acrylic and of a transparent surface layer consisting of a blend of homopolymer PVDF with an acrylic.

Patent WO 94/03337 proposes a multilayer consisting, from the inside to the outside, of a substrate, of an adherent layer consisting of a compound compatible with the substrate, of a reinforcing layer, of a coloured layer which contains pigments in an acrylic, urethane or vinyl matrix, and finally of a transparent layer based on PVDF and PMMA having a composition gradient. The reinforcing layer may consist of PBT, PET, ABS, PVC, PA, a polyester, PC, a polyolefin, an ethylene/alkyl (meth)acrylate copolymer, an acrylic polymer or a blend of at least any two of these polymers.

U.S. Pat. No. 5,658,670 describes a two-layer film obtained by coextrusion and hot-pressing of a layer of PVDF or derivatives and of an amine-modified PA, polyurethane or polyolefin layer. In the films of the prior art mentioned above, the weak point is the adhesion of the fluoropolymer layer to the other layers. The prior art has therefore proposed films in which the adhesion of the fluoropolymer layer to the other layers is greatly improved.

Thus, U.S. patent application Ser. No. 2001051256 describes a thermoformable multilayer film comprising in succession:
a protective layer (A);
a transparent layer (B) comprising (the total being 100% by weight) 0 to 100% of a fluoropolymer (B1) and 100 to 0% of a polymer (B2) essentially consisting of alkyl (meth)acrylate units;
a layer (C) based on a polyamide with amine terminal groups;
a layer (D) consisting of a polyolefin functionalized by an unsaturated carboxylic acid anhydride;
a tie layer (E) made of a polyolefin.

This film is obtained by coextruding the various layers, the layer (A) possibly being laminated using the standard technique for thermoplastics. This film is then used to cover various substrates, for example by injection-moulding the substrate in the melt onto the multilayer film placed in the bottom of an injection mould, the layer (A) of the film being placed against the wall of the mould.

It has now been found that if the layer (B) consisted mostly of a functionalized acrylic polymer, then it was possible to replace the layers (C) and (D) with a single layer consisting of a copolymer of ethylene with an alkyl (meth)acrylate carrying an epoxide functional group. The prior art has not disclosed such multilayers.

Patent Application JP 09-193189 A, published on 29 Jul. 1997, describes a film comprising 4 layers which, from the inside to the outside, are a polypropylene layer, a filled (pigmented) polypropylene layer, a layer of an ethylene/glycidyl methacrylate copolymer and a transparent surface layer based on polymethyl methacrylate (PMMA), respectively. In this prior art, PMMA is used in the examples but in the description the functionalized PMMA is not clearly described; in addition, all the acrylic polymers described are presented as being equivalent. It will be seen in the comparative examples of the present invention that this is not the case. In this prior art, the ethylene/glycidyl methacrylate copolymer is described in the examples, whereas in the description other possible comonomers in addition to ethylene and glycidyl methacrylate are mentioned. These other comonomers may be an alkyl (meth)acrylate; in addition, all these products are presented as being equivalent. It will be seen in the comparative examples of the present invention that this is not the case.

### SUMMARY OF THE INVENTION

The present invention relates to a thermoformable multilayer film comprising in succession:
an optional protective layer (A);
a layer (B) comprising (the total being 100% by weight) 0 to 30% of a fluoropolymer (B1) and 100 to 70% of a functionalized polymer (B2) essentially consisting of alkyl (meth)acrylate units;
a layer (C) based on an ethylene/alkyl (meth)acrylate/unsaturated epoxide copolymer;
a polyolefin tie layer (D);
the layers adhering to one another in their respective contact regions.

This film is obtained by coextrusion or coating of the various layers, the layer (A) possibly being laminated using the standard technique for thermoplastics. This film is then used to cover various substrates, for example by injecting the substrate in the melt onto the multilayer film deposited in the bottom of an injection mould, the layer (B) or the optional layer (A) of the film being placed against the wall of the mould.

The present invention also relates to the substrates coated with these films.

### DETAILED DESCRIPTION OF THE INVENTION

The protective layer (A) is a temporary layer allowing the layer (B) to be protected during the steps of handling, thermoforming, and injection-moulding the film. This protective layer makes it possible to maintain or promote a given surface finish. Thus, this layer may be smooth or rough, depending on the desired surface finish. This layer avoids the use of a demoulding agent capable of degrading the surface finish of (B). Advantageously, this layer has a thickness of between 10 and 150 μm and preferably from 50 to 100 μm. The materials that can be used to produce this layer may be chosen from (i) saturated polyesters, such as PET and PBT, copolyesters and polyetheresters and (ii) polyolefin homopolymers or copolymers, such as polyethylenes or polypropylenes. By way of example, mention may be made of the PET sold under the brand name MYLAR® by DuPont. This layer may contain various fillers, such as TiO₂, silica, kaolin, calcium carbonate, aluminium flakes and derivatives thereof.

The surface layer (B) is formed from a polymer or a blend of polymers making it possible to obtain a transparent shiny surface resistant to chemical or external attack or to UV. This layer, advantageously has a thickness ranging from 10 to 1200 μm and preferably from 70 to 500 μm. It will be seen later that this layer is not always transparent, it may be coloured by pigments.

By way of example of fluoropolymers (B1), mention may most particularly be made of:
PVDFs, vinylidene fluoride (VF2) homopolymers and vinylidene fluoride (VF2) copolymers preferably containing at least 50% by weight of VF2 and at least one other fluoromonomer, such as chlorotrifluoroethylene (CTFE), hexafluoropropylene (HFP), trifluoroethylene (VF3) and tetrofluoroethylene (TFE);
trifluoroethylene (VF3) homopolymers and copolymers;
copolymers, and especially terpolymers, combining residues of chlorotrifluoroethylene (CTFE), tetrafluoroethylene (TFE) hexafluoropropylene (HFP) and/or ethylene units and optionally VF2 and/or VF3 units.

Among these fluoropolymers (B 1), it is advantageous to use PVDF.

The polymer (B2) essentially consists of alkyl (meth)acrylate units, advantageously methyl methacrylate units, and is functionalized, that is to say it comprises at least one functional group chosen from acid, acid chloride, alcohol and anhydride functional groups. The alcohol functional group may be provided by hydroxyethyl (meth)acrylate.

Advantageously, the polymer (B2) is a polyalcyl methacrylate comprising the following units: 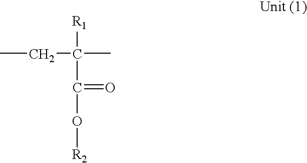
in which:

R₁ represents H or a linear or branched alkyl having from 1 to 20 carbon atoms; and

R₂, which is identical to or different from R₁ when the latter does not represent H, represents a linear or branched alkyl having from 1 to 20 carbon atoms; and the following units: 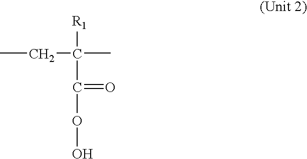
in which:

R₃ represents H or a linear or branched alkyl having from 1 to 20 carbon atoms, in acid form, or its anhydride derivatives or mixtures of the latter.

When unit (2) is present in its anhydride form, it is represented by the following units: 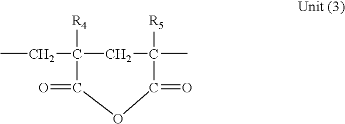
in which:

R₄ and R₅, which are identical or different, represent H or a linear or branched alkyl having from 1 to 20 carbon atoms. It would not be outside the scope of the invention if unit (3) were completely or partly replaced with its imide derivative.

The expression “unit (2), in acid form or its anhydride derivative or mixtures of the latter” covers in particular the following cases: the units (2) are essentially in acid form; the units (2) are essentially in anhydride form, mixtures of units (2) in acid form and in anhydride form, mixtures of units (2) in which the radicals R₃, or R₄ and R₅, are variable.

According to one embodiment, the polymer (B2) comprises up to 30 mol % of unit (2) in acid form or its anhydride derivative or mixtures thereof. Advantageously, the polymer (B2) comprises up to 15 mol % of unit (2), in acid form or its anhydride derivative or mixtures thereof. Advantageously, the unit (1) is methyl methacrylate and the unit (2) is (meth)acrylate acid. According to another embodiment, the unit (1) is a mixture of methyl methacrylate and another acrylate in respective proportions possibly varying from 80/20 to 95/5. This other acrylate is, for example, methyl acrylate or ethyl acrylate.

The abovementioned polymers (B2) may be prepared by any suitable process known in the art. For example, mention may be made of the process described in Patent EP 774 471.

It would not be outside the scope of the invention if (B2) were also to include at least one monomer chosen from acrylonitrile, butadiene, styrene and isoprene, provided that the proportion of alkyl (meth)acrylate is at least 50 mol %.

These polymers (B2) consist either of the monomers and optionally the comonomers mentioned above and do not contain an impact modifier or they contain, in addition, an acrylic impact modifier. The acrylic impact modifiers are, for example, random or block copolymers of at least one monomer chosen from styrene, butadiene, isoprene and at least one monomer chosen from acrylonitrile and alkyl (meth)acrylates; they may be of the core-shell type. These acrylic impact modifiers may be blended with the polymer (B2) once it has been produced or may be introduced during the polymerization of (B2) or they may be produced simultaneously during the polymerization of (B2). The amount of acrylic impact modifier may, for example, be from 0 to 30 parts per 100 to 70 parts of (B2) and advantageously from 5 to 20 parts per 95 to 20 parts of (B2). It would not be outside the scope of the invention if (B2) were a blend of two or more of the above polymers.

Suitable polymers in the case of (B2) are SUMIPEX TR® from Sumitomo® and OROGLAS HT121® from Atoglas and, in the case of (B1), KYNAR 720® from Atofina. This layer may contain various organic and/or inorganic fillers, for example UV absorbers of the TINUVIN® family from Ciba Speciality Chemicals; this layer may also contain pigments or dyes. This layer has very good resistance to the various fluids used in motor vehicles, such as petrol, coolant, windscreen-washer fluid, brake fluid, engine oil and hydraulic transmission fluid. Very good preservation over time of the surface finish and surface appearance of the film is obtained.

Using the extrusion technique, it is possible to orient the pigments or dyes in this layer in the flow direction, making the appearance of the film anisotropic. To do this, all that is required is to use pigments having an anisotropic aspect ratio. By choosing pigments with an isotropic aspect ratio (aspect ratio close to 1) this effect may advantageously be eliminated. This orientation of the pigments gives an interferential effect.

With regard to the layer (C) based on ethylene/alkyl (meth)acrylate/unsaturated epoxide copolymer.

By way of example of unsaturated epoxides, mention may be made of:
aliphatic glycidyl esters and ethers, such as allyl glycidyl ether, vinyl glycidyl ether, glycidyl maleate and glycidyl itaconate, glycidyl (meth)acrylate; and
alicyclic glycidyl esters and ethers, such as 2-cyclohexen-1-yl glycidyl ether, diglycidyl cyclohexene-4,5-dicarboxylate, glycidyl cyclohexene-4-carboxylate, glycidyl 2-methyl-5-norbomene-2-carboxylate and diglycidyl endo-cis-bicyclo-[2.2.1]hept-5-ene-2,3-dicarboxylate.

By way of example of alkyl (meth)acrylates, mention may be made of those in which the alkyls may have up to 24 carbon atoms. Examples of alkyl acrylates or methacrylates are especially methacrylate, ethyl acrylate, n-butyl acrylate, isobutyl acrylate and 2-ethylhexyl acrylate.

These copolymers of the layer (C) may be copolymers obtained by radical polymerization of the monomers: ethylene, alkyl (meth)acrylate and unsaturated epoxide. Optionally, this copolymer may include other monomers such as:
alpha-olefins, advantageously those having from 3 to 30 carbon atoms; as examples of alpha-olefins, mention may be made of propylene, 1-butene, 1-pentene, 3-methyl-1-butene, 1-hexene, 4-methyl-1-pentene, 3-methyl-1-pentene, 1-octene, 1-decene, 1-dodecene, 1-tetradecene, 1-hexadecene, 1-oxtadecene, 1-eicocene, 1-dococene, -tetracocene, 1-hexacocene, 1-octacocene and 1-triacontene; these alpha-olefins may be used by themselves or as a mixture of two or more of them;
vinyl esters of saturated carboxylic acids such as, for example, vinyl acetate or vinyl propionate;
dienes such as, for example, 1,4-hexadiene.

These copolymers of the layer (C) may also be copolymers of ethylene with an alkyl (meth)acrylate and optionally an alpha-olefin or a vinyl ester or a diene, onto which the unsaturated epoxide is grafted. The grating operation is known per se.

The copolymers of the layer (C) are advantageously ethylene/alkyl (meth)acrylate/unsaturated epoxide copolymers obtained by copolymerization of the monomers and not by grafting of the unsaturated expoxide. Advantageously, they contain from 5 to 40%, preferably 10 to 40% and better still 20 to 35% by weight of alkyl (meth)acrylate. The proportion of epoxide may be between 0.5 and 10% and preferably between 2 and 9% by weight. Advantageously, the epoxide is glycidyl (meth)acrylate (GMA). The MFI (the abbreviation for melt flow index) is advantageously between 5 and 100 (in g/10 min at 190° C./2.16 kg) and the melting point is between 60 and 110° C.

It would not be outside the scope of the invention if the layer (C) were to consist (i) of a copolymer of ethylene with an unsaturated epoxide and optionally an alkyl (meth)acrylate blended with (ii) a homopolymer polyethylene or a copolymer of ethylene with at least one monomer chosen from alpha-olefins, alkyl (meth)acrylates, vinyl esters and dienes, provided that at least one of the constituents (i) and (ii) contains an alkyl (meth)acrylate. Advantageously, the blend (i)+(ii) contains from 5 to 40%, preferably 10 to 40% and better still 20 to 35% by weight of alkyl (meth)acrylate.

Advantageously, this layer has a thickness of 10 to 1200 μm and preferably 70 to 500 μm.

The tie layer (D), which makes it possible to bond to the substrate, is a polyolefin—the polyolefins were defined in the layer (D). These materials have sufficient compatibility and sufficient affinity in order to allow bonding between the layer (D) and the substrate. Advantageously, polypropylene is used. Materials perfectly suitable for producing this layer are the polypropylenes 3050 BN1 and 3060 MN5 from Appryl. The thickness of this layer is advantageously between 400 and 1200 μm and preferably between 500 and 600 μm. This layer may contain various organic and/or inorganic fillers, for example UV absorbers from the TINUVIN® family from Ciba Speciality Chemicals; this layer may also contain pigments or dyes.

Using the extrusion technique, it is possible to orient the pigments or dyes in this layer in the flow direction, making the appearance of the film anisotropic. To do this, all that is required is to use pigments having an anisotropic aspect ratio. By choosing pigments with an isotropic aspect ratio (aspect ratio close to 1), this effect may advantageously be eliminated. This orientation of the pigments gives an interferential effect.

The film of the invention is manufactured by coextrusion using a standard technique for thermoplastics, in which the molten material of the various layers is forced through sheet dies placed very close to each other; the combination of molten materials forms the multilayer film which is cooled by passing over controlled-temperature rolls. By adjusting the speeds of rolls placed in the machine direction and/or rolls placed in the cross direction, it is possible to stretch the film in the machine direction and/or in the cross direction.

The MFIs of the various layers are chosen to be as close as possible, between 1 and 20 (at 230°/2.16kg) and are advantageously between 4 and 7; this choice falls within the competence of those skilled in the art of coextrusion.

The multilayer film of the invention is useful for covering substrates, either by overmoulding or by coextrusion or by coating or by hot-pressing. Advantageously, the overmoulding technique is used. If the mould is of simple shape, the injection moulding moulding of the substrate in the melt is sufficient to press the film against the wall of the mould; in this case the film is used as obtained. If the mould is of more complicated shape, to avoid stresses in the film and to ensure a good contact between the film and the walls of the moulds, it is necessary to preform the film by thermoforming before putting it into the mould. It is possible to use another mould of the same shape and, with the aid of a part having the same shape, but as the positive, the film is thermoformed; it is also possible to use the same mould which serves for injection-moulding the substrate. It is also possible, in the case of conditions intermediate between those of the above, not to carry out thermoforming but to put the film as it is in the mould and, using compressed air on the side where the substrate is injection-moulded, to press the film against the wall of the mould. It is also possible to create a vacuum on the other side of the film in order to press it against the wall of the mould.

If the film has to be thermoformed, the products used must have a thermoforming temperature range having as wide as possible an overlap.

The various layers may contain fillers and additives, provided that the properties of the upper layer (B) and the colours and colour effects of the entire structure are not affected.

The invention is particularly useful for covering polypropylene substrates.

### EXAMPLES

### Example 1 (Example According to the Invention)

A plaque 1 mm in thickness made of a polypropylene, PP 3060MN5 from Atofina having an MVI (melt volume index) of 6.5 cm³/10 minutes at 230° C./2.16 kg, a plaque 1 mm in thickness made of a LOTADER® AX8900 (an ethylene/methyl acrylate/glycidyl methacrylate copolymer containing 25% by weight of acrylate and 8% by weight of GMA) from Atofina having an MFI of 6 g/10 minutes at 190° C./2.16 kg and a plaque 0.3 mm in thickness made of PMMA, OROGLAS® HT121 (containing 8% by weight of acylic acid and 2% by weight of methylacrylate) from Atofina having an MFI of 2 g/10 minutes at 230° C./3.8 kg were produced. The HT121 plaque was brought into contact with the LOTADER AX8900 which itself was brought into contact with the PP 3060MN5. This structure was placed in a press at 240° C. under the following conditions: 2 minutes of preheating, 2 minutes at 40 bar and 4 minutes of cooling at 40 bar. Specimens were then cut into 2 cm test pieces in order to carry out a peel test at 20 mm/minute. The peel force for the PP/LOTADER interface was 15.5 N/cm, the HT 121 /LOTADER interface being uninitiatable.

### Example 2 (Comparative)

A plaque 1 mm in thickness made of a propropylene, PP 3060MN5 from Atofina having an MFR of 6.5 cm³/10 minutes at 230° C./2.16 kg, a plaque 1 mm in thickness made of a LOTADER AX8900 from Atofina having an MFI of 6 g/10 minutes at 190° C./2.16 kg and a plaque 0.3 mm in thickness made of PMMA, OROGLAS® V825T from Atofina having an MFI of 2.5 g/10 minutes at 230° C./3.8 kg, this PMMA not having any reactive functional group in its chain, were produced. The V825T plaque was brought into contact with the LOTADER AX8900 which itself was in contact with the PP 3060MN5. This structure was placed in a press at 240° C. under the following conditions: 2 minutes of preheating, 2 minutes at 40 bar and 4 minutes of cooling at 40 bar. Specimens were then cut into 2 cm test pieces in order to carry out a peel test at 20 mm/minute. The peel force for the PP/LOTADER interface was 11 N/cm, there being no adhesion at the PMMA/LOTADER interface.

### Example 3 (Example According to the Invention)

A plaque 1 mm in thickness made of a polypropylene, PP 3060 MN5 from Atofina having an MFR of 6.5 cm³/10 minutes at 230° C./2.16 kg, a plaque 1 mm in thickness made of a LOTADER® AX8930 (an ethylene/methyl acrylate/glycidyl methacrylate copolymer containing 24% by weight of acrylate and 3% by weight of GMA) from Atofina having an MFI of 6 g/10 minutes at 190° C./2.16 kg and a plaque 0.3 mm in thickness made of PMMA, OROGLAS® HT121 from Atofina having an MFI of 2 g/10 minutes at 230° C./3.8 kg were produced. The HT121 plaque was brought into contact with the LOTADER AX8930 which itself was in contact with the PP 3060MN5. This structure was placed in a press at 240° C. under the following conditions: 2 minutes of preheating, 2 minutes at 40 bar and 4 minutes of cooling at 40 bar. Specimens were then cut into 2 cm test pieces in order to carry out a peel test at 20 mm/minute. The peel force for the PP/LOTADER interface was 12 N/cm, the HT 121 /LOTADER interface being uninitiatable.

### Example 4 (Comparative)

A plaque 1 mm in thickness made of a polypropylene, PP 3060MN5 from Atofina having an MFR of 6.5 cm³/10 minutes at 230° C./2.16 kg, a plaque 1 mm in thickness made of a LOTADER® AX8840 (an ethylene/glycidyl methacrylate copolymer containing 8% by weight of GMA) from Atofina having an MFI of 5 g/10 minutes at 190° C./2.16 kg and a plaque 0.3 mm in thickness made of PMMA, OROGLAS HT121 from Atofina having an MFI of 2 g/10 minutes at 230° C./3.8 kg were produced. The HT121 plaque was brought into contact with the LOTADER AX8840 which itself was in contact with the PP 3060MN5. This structure was placed in a press at 240° C. under the following conditions: 2 minutes of preheating, 2 minutes at 40 bar and 4 minutes of cooling at 40 bar. Specimens were then cut into 2 cm test pieces in order to carry out a peel test at 20 mm/minute. The peel force for the PP/LOTADER interface was 1.5 N/cm, the HT 121 /LOTADER interface being uninitiatable.

1. Thermoformable multilayer film comprising in succession:
an optional protective layer (A);
a layer (B) comprising (the total being 100% by weight) 0 to 30% of a fluoropolymer (B1) and 100 to 70% of a functionalized polymer (B2) consisting essentially of alkyl (meth)acrylate units;
a layer (C) based on an ethylene/alkyl (meth)acrylate/unsaturated epoxide copolymer;
a polyolefin tie layer (D);
wherein the layers adhering to one another in their respective contact regions.

2. Film according to claim 1, in which the materials of the layer (A) are selected from the group consisting of (i) saturated polyesters, copolyesters and polyetheresters and (ii) homopolymers or copolymers polyolefins.

3. Film according to claim 1, in which the fluoropolymer (B1) is PVDF.

4. Film according to claim 1, in which the polymer (B2) comprises at least one functional group chosen from acid, acid chloride, alcohol and anhydride functional groups.

5. Film according to claim 4, in which the polymer (B2) is a polyalkyl methacrylate comprising the following units: 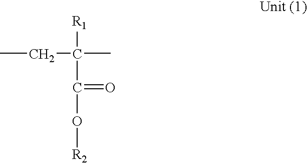
in which:
R₁ represents H or a linear or branched alkyl having from 1 to 20 carbon atoms; and
R₂, which is identical to or different from R₁ when the latter does not represent H, represents a linear or branched alkyl having from 1 to 20 carbon atoms; and the following units: 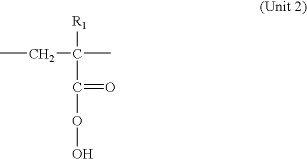
in which:
R₃ represents H or a linear or branched alkyl having from 1 to 20 carbon atoms, in acid form, or its anhydride derivatives or mixtures of the latter.

6. Film according to claim 1, in which the ethylene/alkyl (meth)acrylate/unsaturated epoxide copolymer of the layer (C) contains from 5 to 40% by weight of alkyl (meth)acrylate.

7. Film according to claim 6, in which the ethylene/alkyl (meth)acrylate/unsaturated epoxide copolymer of the layer (C) contains from 10 to 40% by weight of alkyl (meth)acrylate.

8. Film according to claim 7, in which the ethylene/alkyl (meth)acrylate/unsaturated epoxide copolymer of the layer (C) contains from 20 to 35% by weight of alkyl (meth)acrylate.

9. Film according to claim 1, in which the layer (C) consists (i) of a copolymer of ethylene with an unsaturated epoxide and optionally an alkyl (meth)acrylate blended with (ii) a homopolymer polyethylene or a copolymer of ethylene with at least one monomer chosen from alpha-olefins, alkyl (meth)acrylates, vinyl esters and dienes, provided that at least one of the constituents (i) and (ii) contains an alkyl (meth)acrylate.

10. Film according to claim 9, in which the blend (i)+(ii) contains from 5 to 40% by weight of alkyl (meth)acrylate.

11. Film according to claim 10, in which the blend (i)+(ii) contains from 10 to 40% by weight of alkyl (meth)acrylate.

12. Film according to claim 11, in which the blend (i)+(ii) contains from 20 to 35% by weight of alkyl (meth)acrylate.

13. Film according to any one of the preceding claims, in which the polyolefin of the layer (D) is polypropylene.

14. Substrate coated with a film claim 1, in which the layer (D) of the film is against the substrate.

15. Substrate according to claim 14, wherein said substrate is made of polypropylene.
